(19) United States
(12) Patent Application Publication
(10) Pub. No.: US 2016/0306149 A1
(43) Pub. Date: Oct. 20, 2016

(54) CASSEGRAIN TELESCOPE WITH ANGLED REFLECTOR

(71) Applicant: VISIONMAP LTD., Tel-Aviv (IL)

(72) Inventors: Shai EISENBERG, Givat Ella (IL); Alexander LAMIN, HOLON (IL); Yochay DANZIGER, Kfar Vradim (IL)

(21) Appl. No.: 14/907,299

(22) PCT Filed: Jan. 13, 2016
(86) PCT No.: PCT/IL16/50034

§ 371 Date: Jan. 25, 2016

Related U.S. Application Data
(60) Provisional application No. 62/110,650, filed on Feb. 2, 2015.

(51) Int. Cl. G02B 17/06; H04N 5/33; G02B 27/64; G02B 23/06; G02B 27/14

(52) U.S. Cl. CPC G02B 17/0631; G02B 23/06; G02B 27/141; G02B 27/646; H04N 5/332

(57) ABSTRACT

A Cassegrain optical system has a concave primary mirror deployed for receiving incident electromagnetic radiation and generating once-reflected rays, a convex secondary mirror deployed for receiving the once-reflected rays and generating twice-reflected rays, a tertiary reflector deployed for receiving the twice-reflected rays and generating thrice-reflected rays, and a beam-folding optical element deployed between the primary mirror and the secondary mirror for deflecting the thrice-reflected rays laterally so as to exit a volume between the primary and secondary mirrors.

### FIELD AND BACKGROUND OF THE INVENTION

The present invention relates to optical arrangements and, in particular, it concerns a Cassegrain optical system.

It is known to employ a Cassegrain telescope with various focal geometries. In some cases, an optical path of the twice-reflected light from the Cassegrain telescope passes out through an axial opening in the primary mirror. In other cases, a beam-folding reflector is used to provide a laterally-deflected beam, sometimes referred to as a Cassegrain-Nasmyth arrangement. In certain cases, where dual-channel multi-spectral imaging is required, a dichroic beam-folding reflector may be used to split incident light into two separate channels of different spectral bands for imaging according to both of the above geometries. One example of such an arrangement, as disclosed by US pre-grant publication no. US 2013/0105695, is illustrated in FIGS. 7A and 7B, where FIG. 7A shows the optical path for the spectral band reflected by the dichroic mirror (230) and FIG. 7B shows the optical path for the spectral band transmitted by dichroic mirror (230).

The tilted dichroic mirror (230) of the aforementioned publication separates the two channels to create a Cassegrain-Nasmyth architecture for the visible channel and a conventional Cassegrain arrangement for the IR channel. Transmission of the IR channel through the inclined plate of the dichroic mirror causes an optical distortion to the IR channel. Partial compensation for this distortion is achieved by employing a reverse-tilted window (310), but this element does not fully compensate for the distortion and is sensitive to misalignment and tolerances of its optical components. Furthermore, design and manufacture of a tilted dichroic reflector is complicated and tend to induce additional losses to the optical path.

### SUMMARY OF THE INVENTION

The present invention is a Cassegrain optical system.

According to the teachings of an embodiment of the present invention there is provided, a Cassegrain optical system comprising: (a) a concave primary mirror deployed for receiving incident electromagnetic radiation and generating once-reflected rays; (b) a convex secondary mirror deployed for receiving the once-reflected rays and generating twice-reflected rays; (c) a tertiary reflector deployed for receiving the twice-reflected rays and generating thrice-reflected rays; and (d) a beam-folding optical element deployed between the primary mirror and the secondary mirror for deflecting the thrice-reflected rays laterally so as to exit a volume between the primary and secondary mirrors.

According to a further feature of an embodiment of the present invention, the primary mirror, the secondary mirror and the tertiary reflector are symmetrical about a shared primary optical axis of the system.

According to a further feature of an embodiment of the present invention, the tertiary reflector is deployed axisymmetrically to a primary optical axis of the system.

According to a further feature of an embodiment of the present invention, the beam-folding optical element is deployed within a central shadow of the once-reflected rays from the primary mirror.

According to a further feature of an embodiment of the present invention, the beam-folding optical element is deployed within a central shadow of the twice-reflected rays reflected from the primary mirror and the secondary mirror.

According to a further feature of an embodiment of the present invention, the tertiary reflector is a dichroic optical element deployed to reflect a first spectral channel towards the beam-folding optical element and to transmit a second spectral channel.

According to a further feature of an embodiment of the present invention, the first spectral channel is within the infrared band and the second spectral channel includes at least part of the visible light band.

According to a further feature of an embodiment of the present invention, there is also provided an infrared imaging system including a focal plane array sensor deployed in optical alignment with the beam-folding reflector, and a visible light imaging system including at least one focal plane array sensor deployed in optical alignment for receiving the twice-reflected rays transmitted by the dichroic optical element.

According to a further feature of an embodiment of the present invention, the first and second spectral channels do not pass through any common refractive component other than a window or dome without optical power encountered by the incident electromagnetic radiation before reaching the concave primary mirror.

According to a further feature of an embodiment of the present invention, the secondary mirror is supported by an actuator arrangement which forms part of an image stabilization system.

### BRIEF DESCRIPTION OF THE DRAWINGS

The invention is herein described, by way of example only, with reference to the accompanying drawings, wherein:

FIG. 1 is a schematic representation of an optical system according to an embodiment of the present invention, providing dual-channel imaging;

FIG. 2 is a ray diagram of a Cassegrain arrangement illustrating a region of shade from a secondary reflector cast in once-reflected and twice-reflected light between the primary and secondary mirrors;

FIG. 3 is a schematic representation of an optical system according to a further embodiment of the present invention, for imaging a single spectral channel;

FIG. 4 is a schematic representation of a variant implementation of the optical system of FIG. 3;

FIG. 5 is a first variant implementation of the optical system of FIG. 1;

FIG. 6 is a second variant implementation of the optical system of FIG. 1; and

FIGS. 7A and 7B (prior art) are reproductions of FIGS. 4 and 5, respectively, of US Patent Application Publication No. US 2013/0105695 A1.

### DESCRIPTION OF THE PREFERRED EMBODIMENTS

The present invention is a Cassegrain optical system.

The principles and operation of optical systems according to the present invention may be better understood with reference to the drawings and the accompanying description.

Referring now to the drawings, FIG. 1 schematically depicts an embodiment of the present invention. Light 290 (“incident light”, marked as a fine dashed line) over the entire spectral bandwidth of interest enters the telescope and is reflected by a primary mirror/reflector 310 to generate “once-reflected light”. It is then reflected by a secondary mirror 320 to generate “twice-reflected light”, which is directed towards an axisymmetrically deployed dichroic optical element 330. This dichroic optical element transmits part of the spectrum (marked as long dashed line) that is to be detected by a sensor 340. Another part of the spectrum is reflected by dichroic optical element 330, acting as a tertiary reflector, to generate “thrice-reflected light”, which is directed towards a beam-folding optical element, or “folding reflector” 350 which reflects the light towards a sensor 360. Folding reflector 350 can be a prism or a dielectric or metallic mirror. In the case of a prism, the input and output beams pass through refractive surfaces, which may be planar or may be shaped optical elements with optical power. Sensors 340 and 360, represented here schematically as boxes, typically each include a focal plane array (FPA) sensitive to the corresponding spectral range to be imaged, and may include additional optical elements (reflective, refractive or other) for further folding the received beam of radiation and/or for focusing it on the FPA, all as is well known in the art.

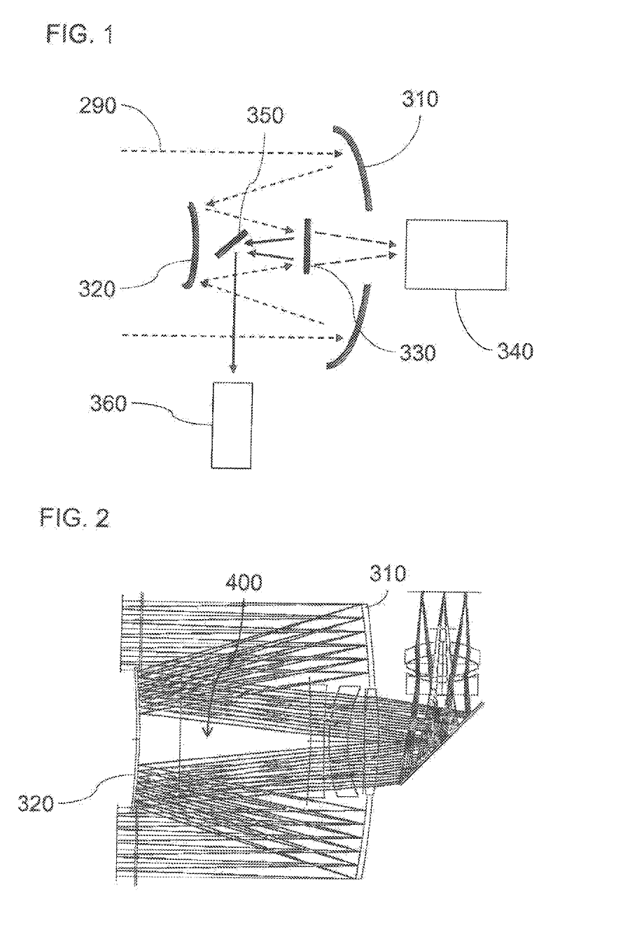

The primary mirror 310 and the secondary mirror 320 preferably constitute a basic Cassegrain architecture. The terms “Cassegrain architecture”, “Cassegrain optics” or “Cassegrain telescope” are used herein generically to refer to any of the family of optical arrangements employing a concave primary mirror and a convex secondary mirror to provide part of a folded-optical-path telescope, independent of the exact mirror type (spherical, parabolic, hyperbolic or other) and focal geometry. In this architecture, the secondary mirror, together with any associated baffles or other structures, creates a central obscuration of the entrance pupil. As a result, no light illuminates the central section of the secondary mirror as shown in FIG. 2, such that secondary mirror 320 and any associated structures effectively cast a central shadow in the incident light, the once-reflected light and the twice-reflected light. Other factors may also contribute to the central shadow such as, for example, the inner extent of the primary mirror and any baffles or other structures associated therewith may also contribute to defining the innermost paths of light rays in the once-reflected, and consequently twice-reflected, light. The term “shadow” is used herein to refer to any region through which the once- or twice-reflected beams of radiation from the scene to be imaged do not pass. It follows that a beam-folding optical element deployed in this “shadow” does not reduce the intensity of radiation which is sensed by the imaging sensors. Here, the non-illuminated region of shadow in the twice-reflected light is marked 400. In the non-limiting example of FIG. 5, an additional lens 405 is depicted in front of the telescope as applicable in a Maksutov telescope, which is a one non-limiting example of a Cassegrain telescope to which the invention may be applied. The present invention is applicable to any type of Cassegrain telescope.

In a case where the secondary mirror is off-center relative to the optical entrance pupil but still obscures part of the entrance pupil, an off-axis section of the secondary mirror will not be illuminated (much like 400 in FIG. 2), generating off-axis regions of shade in the twice-reflected and thrice-reflected light. Therefore, the folding mirror 350 should be placed in this off-center section, according to this invention. The shadow here is still referred to herein as a “central shadow” in the sense that it lies within the conically converging ray pattern, although it is off-axis relative to the entrance pupil axis.

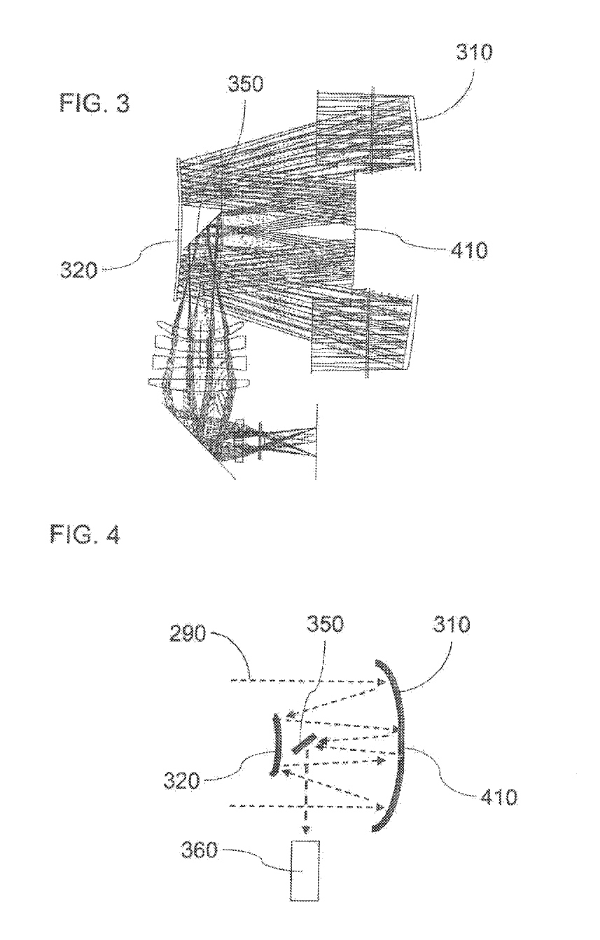

In most preferred embodiments of this invention, the folding mirror 350 is positioned in the non-illuminated central section and hence causes no additional obscuration, as shown in FIG. 3.

It will be appreciated that the arrangement of FIG. 3 is compact, achieving three-times folding of the optical path within the volume between the primary and secondary mirrors before folding the beam in a transverse direction, and is therefore advantageous to be used even for a single channel and single sensor. For a single channel implementation, the tertiary reflector may be implemented as a mirror 410 (rather than the dichroic optical element 330 illustrated in FIG. 1, above). Where a mirror 410 is used, this may optionally be integrated in a single physical mirror element which provides both primary reflector 310 and tertiary mirror 410, hence simplifying the arrangement as depicted in FIG. 4. Alternatively, even for a single channel implementation, reflector 410 may be a dichroic optical element, as was illustrated above in FIG. 1, thereby rejecting unwanted portions of the spectrum.

FIG. 5 shows a combined optical arrangement, similar to FIG. 1, with two spectral channels (reflected and transmitted, respectively, by the dichroic optical element). In this non-limiting embodiment, dichroic optical element 330 is a surface of a lens used for the transmitted channel.

The two-channel arrangements of the present invention may be used to implement multi-spectral imaging with a wide range of pairs of spectral bands separated by a suitably chosen dichroic optical element 330 and subsequently focused by suitable optics on suitable detectors. Two-channel implementations of the invention may be applied essentially to any pair of wavelength bands between 0.35 and 15 microns wavelength. By way of non-limiting examples, possible pairs of wavelength bands for which the present invention may be used to advantage include, but are not limited to, the following examples:

| | | |
|---|---|---|
| 1 | VIS (0.4-0.7 microns) | NIR (0.7-1 microns) |
| 2 | VIS (0.4-0.7 microns) | SWIR (1.4-2.6 microns) |
| 3 | VIS (0.4-0.7 microns) | MWIR (3.6-5.2 microns) |
| 4 | SWIR (1.4-2.6 microns) | MWIR (3.6-5.2 microns) |
| 5 | SWIR (1.4-2.6 microns) | LWIR (8-12 microns) |
| 6 | MWIR (3.6-5.2 microns) | LWIR (8-12 microns) |

In one particularly advantageous subset of embodiments, where one channel is used for IR radiation in the 3400 to 15000 nanometer wavelength, the longer internal optical path of the reflected channel may be used to advantage for the thermal IR channel, with the entrance pupil imaged onto the cold shield 430 before being imaged on the detector plane 440. The transmitted channel in the embodiment illustrated here is focused directly onto the sensor located at plane 420, which is appropriate, for example, for non-thermal radiation (in the wavelength range of 350 to 2500 nanometers) since it doesn't require a cold shield. It should be noted however that reverse configurations, with the transmitted optical path employed for thermal IR imaging, may also be used, all according to the requirements of each given application.

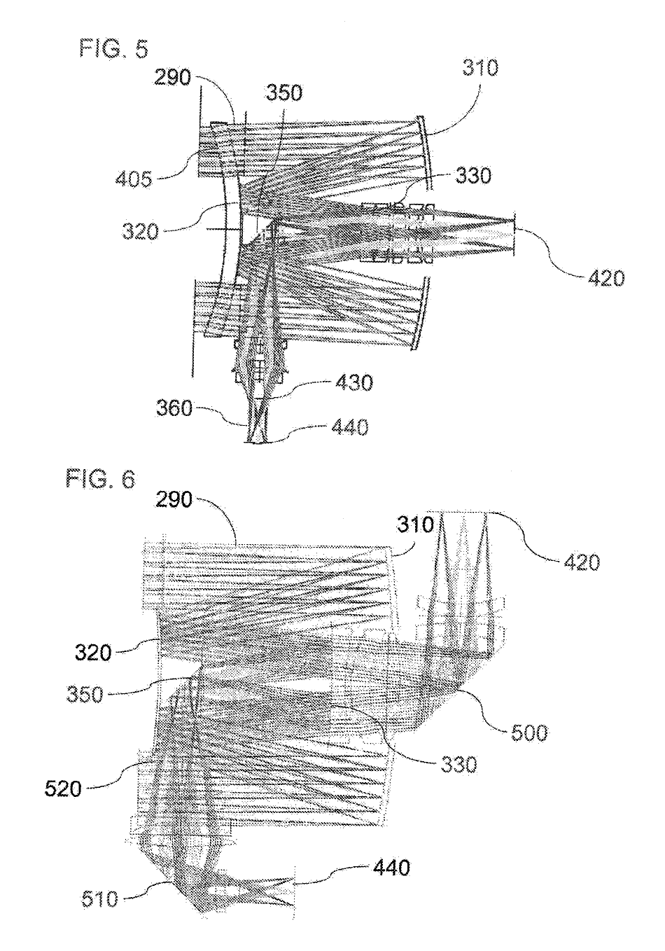

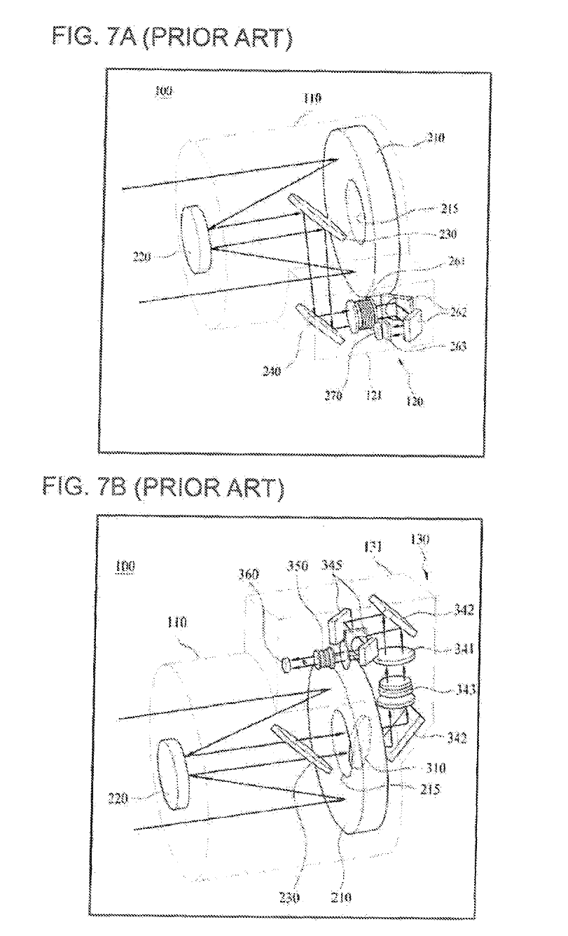

In certain preferred implementations, the two channels depicted in FIG. 5 can be further folded as shown in FIG. 6. As in FIG. 5, FIG. 6 shows both an optical transmitted channel to detector 420 and a reflected channel to detector 440. However in this architecture, the two channels are further folded by mirrors 500 and 510, respectively, so that the size and volume of the system are further reduced. Optionally, mirrors 500 and/or 510 may be provided with support structures with active drive components (e.g., piezo-electric or electromagnetic actuator mechanism, or any other suitable high-speed actuator, not shown) to actively tilt and move the mirrors in order to correct for focus and/or tilt errors. The mirrors (320, 500 and 510) can also be tilted in order to achieve image stabilization in a manner known in the art, optionally also providing stepped correction (“back-scan”) to stabilize the effective optical axis during the exposure time of each sampled frame while the optical arrangement is moved in a smooth scanning motion, such as is disclosed in US pre-grant publication US 2010/0277587 A1.

A particular advantage of certain configurations of the present invention is that use of a suitable drive mechanism as part of an image stabilization arrangement associated with secondary mirror 320 allows for accurate stabilization and/or back-scan for both channels (for sensor 420 and for 440) simultaneously using a single stabilization arrangement.

In certain preferred implementations, the optics of the reflected channel that receives the laterally-deflected light from beam-folding optical element 350 partially obscures the incoming light beam, as illustrated by elements 520 in FIG. 6. Although optical components 520 in this implementation obscure some of the light entering the system, the obscuration is a relatively small proportion of the overall objective optical aperture, and the configuration is advantageous in that it renders the overall size of the optical system, including the optics of the reflected channel that goes to detector 440, highly compact.

Thus, in summary, certain embodiments of the present invention provide a Cassegrain optical system which has a concave primary mirror deployed for receiving incident electromagnetic radiation and generating once-reflected rays, a convex secondary mirror deployed for receiving the once-reflected rays and generating twice-reflected rays, a tertiary reflector deployed for receiving the twice-reflected rays and generating thrice-reflected rays, and a beam-folding optical element deployed between the primary mirror and the secondary mirror for deflecting the thrice-reflected rays laterally so as to exit a volume between the primary and secondary mirrors.

In a first set of particularly preferred implementations, the primary mirror, the secondary mirror and the tertiary reflector are symmetrical about a shared primary optical axis of the system.

The tertiary reflector is, in certain particularly preferred implementations, deployed axisymmetrically to a primary optical axis of the system. The tertiary reflector may be a planar reflector, or may be shaped to provide any desired optical power as part of the overall optical arrangement.

The beam-folding optical element is preferably deployed in a central shadow cast by the secondary mirror or other components of the assembly in the once-reflected rays from the primary mirror, and most preferably in a central shadow in the twice-reflected rays reflected from the primary mirror and the secondary mirror.

For two-channel (multi-spectral) imaging, the tertiary reflector is preferably a dichroic beam-splitting optical element, such as a dichroic reflector, deployed to reflect a first spectral channel towards the beam-folding optical element and to transmit a second spectral channel, with or without refractive optical power. In one particularly preferred implementation, the first spectral channel is within the infrared band, most preferably, within a range of thermal radiation imaging, and the second spectral channel includes at least part of the visible light band. In that case, an infrared imaging system including a focal plane array sensor is preferably deployed in optical alignment with the beam-folding reflector, and a visible light imaging system including at least one focal plane array sensor is preferably deployed in optical alignment for receiving the twice-reflected rays transmitted by the dichroic beam-splitting optical element.

In certain particularly preferred implementations, the first and second spectral channels do not pass through any common refractive component other than a window or dome without optical power which is encountered by the incident electromagnetic radiation before reaching the concave primary mirror. A window or dome located prior to the first converging optical element does not typically introduce problems of spectral dispersion. The exclusive use of reflective optics for all shared optical components beyond the window or dome according to this option avoids spectral dispersion, rendering the device advantageous for multi-spectral imaging for pairs of widely spaced wavelengths.

In various particularly preferred implementations, the secondary mirror is supported by an actuator arrangement which forms part of an image stabilization system.

It will be appreciated that the above descriptions are intended only to serve as examples, and that many other embodiments are possible within the scope of the present invention as defined in the appended claims.

What is claimed is:

1. A Cassegrain optical system comprising:
(a) a concave primary mirror deployed for receiving incident electromagnetic radiation and generating once-reflected rays;
(b) a convex secondary mirror deployed for receiving the once-reflected rays and generating twice-reflected rays;
(c) a tertiary reflector deployed for receiving the twice-reflected rays and generating thrice-reflected rays; and
(d) a beam-folding optical element deployed between said primary mirror and said secondary mirror for deflecting the thrice-reflected rays laterally so as to exit a volume between said primary and secondary mirrors.

2. The system of claim 1, wherein said primary mirror, said secondary mirror and said tertiary reflector are symmetrical about a shared primary optical axis of the system.

3. The system of claim 1, wherein said tertiary reflector is deployed axisymmetrically to a primary optical axis of the system.

4. The system of claim 1, wherein said beam-folding optical element is deployed within a central shadow of the once-reflected rays from said primary mirror.

5. The system of claim 1, wherein said beam-folding optical element is deployed within a central shadow of the twice-reflected rays reflected from said primary mirror and said secondary mirror.

6. The system of claim 5, wherein said tertiary reflector is a dichroic optical element deployed to reflect a first spectral channel towards the beam-folding optical element and to transmit a second spectral channel.

7. The system of claim 1, wherein said tertiary reflector is a dichroic optical element deployed to reflect a first spectral channel towards the beam-folding optical element and to transmit a second spectral channel.

8. The system of claim 7, wherein said first spectral channel is within the infrared band and said second spectral channel includes at least part of the visible light band.

9. The system of claim 8, further comprising an infrared imaging system including a focal plane array sensor deployed in optical alignment with said beam-folding reflector, and a visible light imaging system including at least one focal plane array sensor deployed in optical alignment for receiving the twice-reflected rays transmitted by said dichroic optical element.

10. The system of claim 7, wherein said first and second spectral channels do not pass through any common refractive component other than a window or dome without optical power encountered by the incident electromagnetic radiation before reaching said concave primary mirror.

11. The system of claim 1, wherein said secondary mirror is supported by an actuator arrangement which forms part of an image stabilization system.
